(19) United States
(12) Patent Application Publication
(10) Pub. No.: US 2023/0103911 A1
(43) Pub. Date: Apr. 6, 2023

(54) Leveraging Public Data in Training Neural Networks with Private Mirror Descent

(71) Applicant: Google LLC, Mountain View, CA (US)

(72) Inventors: Om Dipakbhai Thakkar, Fremont, CA (US); Ehsan Amid, Mountain View, CA (US); Arun Ganesh, Seattle, WA (US); Rajiv Mathews, Sunnyvale, CA (US); Swaroop Ramaswamy, Mountain View, CA (US); Shuang Song, Mountain View, CA (US); Thomas Steinke, Mountain View, CA (US); Vinith Suriyakumar, Mountain View, CA (US); Abhradeep Guha Thakurta, Los Gatos, CA (US)

(73) Assignee: Google LLC, Mountain View, CA (US)

(21) Appl. No.: 17/937,825

(22) Filed: Oct. 4, 2022

Related U.S. Application Data
(60) Provisional application No. 63/262,129, filed on Oct. 5, 2021.

(51) Int. Cl. G06N 3/08

(52) U.S. Cl. CPC G06N 3/08

(57) ABSTRACT

A method include obtaining a set of differentially private (DP) gradients each generated based on processing corresponding private data, and obtaining a set of public gradients each generated based on processing corresponding public data. The method also includes applying mirror descent to the set of public gradients to learn a geometry for the set of DP gradients, and reshaping the set of DP gradients based on the learned geometry. The method further includes training a machine learning model based on the reshaped set of DP gradients.

### CROSS REFERENCE To RELATED APPLICATIONS

This U.S. Patent Application claims priority under 35 U.S.C. § 119(e) to U.S. Provisional Application 63/262,129, filed on Oct. 5, 2021. The disclosure of this prior application is considered part of the disclosure of this application and is hereby incorporated herein by reference in its entirety.

### TECHNICAL FIELD

This disclosure relates to leveraging public data in training neural networks with private mirror descent.

### BACKGROUND

Differentially private (DP) training is commonly used for training private models on private data such that sensitive information cannot be revealed from the private data. Differentially private stochastic gradient descent (DP-SGD) has become the de facto standard algorithm for training private models using differential privacy.

### SUMMARY

One aspect of the disclosure provides a method including obtaining a set of differentially private (DP) gradients each generated based on processing corresponding private data, and obtaining a set of public gradients each generated based on processing corresponding public data. The method also includes applying mirror descent to the set of public gradients to learn a geometry for the set of DP gradients, and reshaping the set of DP gradients based on the learned geometry. The method further includes training a machine learning model based on the reshaped set of DP gradients.

Implementations of the disclosure may include one or more of the following optional features. In some examples, the private data and the public data are derived from a same distribution of sources. In some implementations, each DP gradient in the set of DP gradients is generated by: processing, using a machine learning model, corresponding private data to generate a corresponding predicted private output; determining a private loss function based on the corresponding predicted private output and a corresponding private ground truth; and adding, to a private gradient derived from the private loss function, noise to generate the DP gradient. In some examples, the private loss function is convex and L-Lipschitz.

In some implementations, each public gradient in the set of public gradients is generated by: processing, using a machine learning model, corresponding public data to generate a corresponding predicted public output; determining a public loss function based on the corresponding predicted public output and a corresponding public ground truth; and deriving the public gradient from the public loss function. In some examples, applying mirror descent to the set of public gradients to learn the geometry for the set of DP gradients includes applying mirror descent by using the public gradients derived from the public loss function as a mirror map to learn the geometry for the set of DP gradients. In some examples, the public loss function is strongly convex.

In some examples, the data processing hardware resides on a central server, and the set of DP gradients and the set of public gradients are stored in a central repository residing on the central server. In some implementations, the data processing hardware resides on a remote system; obtaining the set of DP gradients includes receiving the set of DP gradients from one or more client devices via federated learning without receiving any of the corresponding private data; and each DP gradient in the set of DP gradients is generated locally at a respective one of the one or more client devices.

In some implementations, the machine learning model includes an image classification model, a language model, and/or a speech recognition model.

Another aspect of the disclosure provides a system including data processing hardware; and memory hardware in communication with the data processing hardware, the memory hardware storing instructions that when executed on the data processing hardware cause the data processing hardware to perform operations. The operations including obtaining a set of differentially private (DP) gradients each generated based on processing corresponding private data, and obtaining a set of public gradients each generated based on processing corresponding public data. The method also includes applying mirror descent to the set of public gradients to learn a geometry for the set of DP gradients, and reshaping the set of DP gradients based on the learned geometry. The method further includes training a machine learning model based on the reshaped set of DP gradients.

Implementations of the disclosure may include one or more of the following optional features. In some examples, the private data and the public data are derived from a same distribution of sources. In some implementations, each DP gradient in the set of DP gradients is generated by: processing, using a machine learning model, corresponding private data to generate a corresponding predicted private output; determining a private loss function based on the corresponding predicted private output and a corresponding private ground truth; and adding, to a private gradient derived from the private loss function, noise to generate the DP gradient. In some examples, the private loss function is convex and L-Lipschitz.

In some implementations, each public gradient in the set of public gradients is generated by: processing, using a machine learning model, corresponding public data to generate a corresponding predicted public output; determining a public loss function based on the corresponding predicted public output and a corresponding public ground truth; and deriving the public gradient from the public loss function, In some examples, applying mirror descent to the set of public gradients to learn the geometry for the set of DP gradients includes applying mirror descent by using the public gradients derived from the public loss function as a mirror map to learn the geometry for the set of DP gradients. In some examples, the public loss function is strongly convex.

In some examples, the data processing hardware resides on a central server, and the set of DP gradients and the set of public gradients are stored in a central repository residing on the central server. In some implementations, the data processing hardware resides on a remote system; obtaining the set of DP gradients includes receiving the set of DP gradients from one or more client devices via federated learning without receiving any of the corresponding private data; and each DP gradient in the set of DP gradients is generated locally at a respective one of the one or more client devices.

In some implementations, the machine learning model includes an image classification model, a language model, and/or a speech recognition model.

The details of one or more implementations of the disclosure are set forth in the accompanying drawings and the description below Other aspects, features, and advantages will be apparent from the description and drawings, and from the claims.

### DESCRIPTION OF DRAWINGS

FIG. 1 depicts an example system of a machine learning (ML) environment that leverages public data in training neural networks with private mirror descent.

FIG. 2 is a schematic view of an example training process that leverages public data for training a neural network with private mirror descent.

FIG. 3 is a flowchart of an example arrangement of operations for a computer-implemented method for leveraging public data in training a neural network with private mirror descent

FIG. 4 is a schematic view of an example computing device that may be used to implement the systems and methods described herein.

Like reference symbols in the various drawings indicate like elements.

### DETAILED DESCRIPTION

Federated learning of machine learning (ML) models is an increasingly popular technique for training ML model(s). In traditional federated learning, a local ML model is stored locally on a client device of a user, and a global ML model, that is a cloud-based counterpart of the local ML model, is stored remotely at a remote system (e.g., a cluster of servers). The client device, using the local ML model, can process user input(s) detected at the client device to generate predicted output(s), and can compare the predicted output(s) to ground truth(s) to generate client gradient(s). Further, the client device can transmit the client gradient(s) to the remote system. The remote system can utilize the client gradient(s), and optionally additional client gradients generated in a similar manner at additional client devices, to update weights of the global ML model. The remote system can transmit the global ML model, or updated weights of the global ML model, to the client device(s). The client device(s) can then replace their local ML model with the global ML model, or replace the weights of their local ML model with the updated weights of the global ML model, thereby updating the local ML model.

Notably, these global ML models are generally pre-trained. at the remote system prior to utilization in federated learning based on a plurality of remote gradients that are generated remotely at the remote system, and without use of any client gradients generated locally at the client devices. This pre-training is generally based on proxy or biased data that may not reflect data that will be encountered when the global ML model is deployed at the client devices. Subsequent to the pre-training, the weights of these global ML models are usually only updated based on client gradients that are generated at client devices based on data (e.g., private data) that is encountered when the global ML model is deployed at the client devices, and without use of any gradients generated at the remote system. However, updating the weights of these global ML models in this manner can result in catastrophic forgetting of information learned during pre-training. Further, client gradients generated based on certain data (e.g., false positives, false negatives, etc.) may be difficult to obtain at the client devices, thereby resulting in poor performance of the ML models trained using federated learning.

Differentially private stochastic gradient descent (DP-SGD) and its variants have become the de facto standard algorithms for training ML models with differential privacy. While DP-SGD is known to perform well in terms of obtaining both optimal excess empirical risk and excess population risk for convex losses, the obtained error guarantees may suffer from explicit polynomial dependence on the model dimensionality. This polynomial dependence may significantly impact the privacy/utility trade-off when model dimensionality is greater than the number of private training data records in the data set. Because of this, even empirically, when DP-SGD is used to train large deep learning ML models, there may be a significant drop in accuracy when compared to the non-private counterpart. Implementations here are directed toward effectively using public data (e.g., drawn from the same distribution as the original private/sensitive training data set) to improve the privacy/utility trade-offs for DP model training. Specifically, techniques provide a DP variant of mirror descent that uses a loss function generated from public data as a mirror map, and DP gradients on private/sensitive data as a linear term to ensure population risk guarantees for convex losses with no explicit dependence on dimension as long the number of records in the public data set exceeds model dimensionality. As will become apparent, the DP variant of mirror descent, when assisted with public data, can effectively reduce the variance in the noise added to the private gradients in DP model training. The DP model may correspond to any type of neural network model trained using DP-SGD or variants thereof. For instance, the DP neural network model may correspond to an image classification model, a language model, a speech recognition model, a speech-to-speech model, or a text-to-speech model.

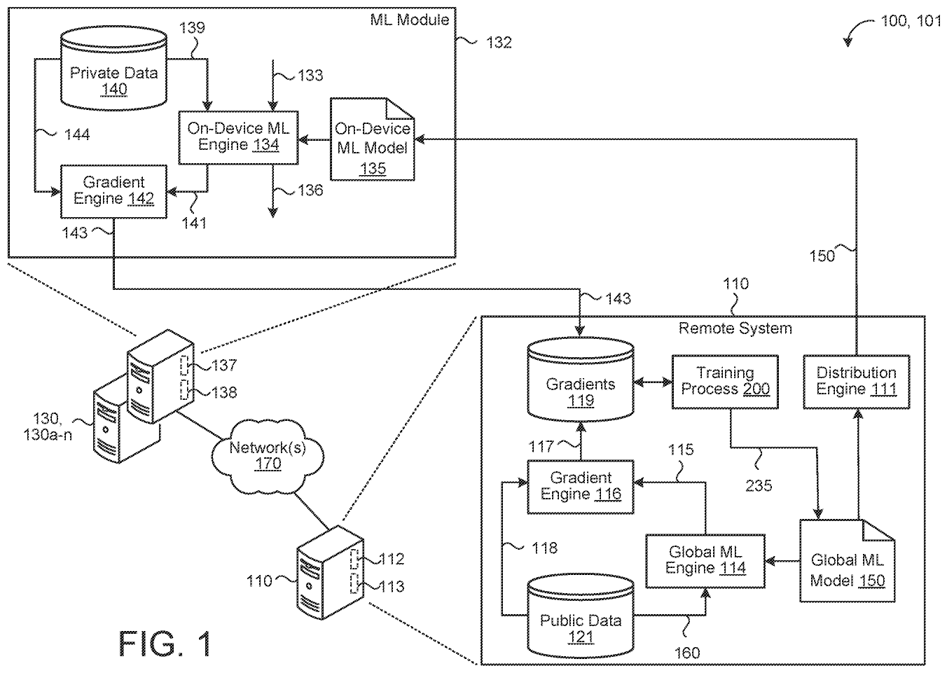

FIG. 1 is a schematic view of an example system 100 operating in an ML environment 101. In the example shown, the system 100 includes a remote system 110 (e.g., a central server) and one or more client devices 130 to perform federated learning (e.g., training) of a global ML model 150 by leveraging public data 160 with private mirror descent. During use or inference, an ML module 132 of each client device 130 is configured to process inputs 133, using an on-device ML engine 134 that executes an on-device ML model 135, to generate outputs 136. In the example shown, a distribution engine 111 of the remote system 110 provides, via one or more communication networks 170 (e.g., any combination of local area networks (LANs), wide area networks (WANs), and/or any other type of network), the global ML model 150 to the ML module 132, or more generally the client devices 130, for use as the on-device ML model 135. The example shown includes the plurality of client devices 130 determining private gradients for corresponding private data, where the private gradients do not expose the private data and can be used by the remote system 110 to update the global ML model 150. However, in other examples, the remote system 110 determines the private gradients for corresponding private data such that the remote system 110 performs substantially all aspects of ML training.

The client devices 130 may correspond to any computing device associated with a user and capable of receiving inputs, processing, and providing outputs. Some examples of user devices 130 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. Each client device 130 includes data processing hardware 137, and memory hardware 138 in communication with the data processing hardware 137. The memory hardware 138 stores instructions that, when executed by the data processing hardware 137, cause the data processing hardware 137 or, more generally, the client device 130 to perform one or more operations. Each client device 130 may include, or may be coupled to, one or more input systems (not shown for clarity of illustration) to capture, record, receive, or otherwise obtain, the inputs 133 among possibly other inputs for the client device 130. Each client device 130 may also include, or be coupled to, one or more output systems (not shown for clarity of illustration) to output or otherwise provide the outputs 136 among possibly other outputs of the client device 130. The input system(s) may be used to obtain inputs from users, other devices, other systems, etc. The output system(s) may be used to provide outputs to users, devices, other systems, etc.

In an example, the inputs 133 include text and the on-device ML model 135 converts the text to synthesized speech as an output 136. For instance, the on-device ML model 135 may convert input text into corresponding synthesized speech to provide the synthesized speech as part of a spoken interactive exchange between a client device 130 and a user. Additionally or alternatively, the inputs 133 include audio data characterizing a spoken utterance recorded by the client device 130, and the on-device ML model 135 performs speech recognition on the audio data characterizing the spoken utterance to generate a transcription of the utterance as an output 136. For instance, the on-device ML model 135 employed as a speech recognition model may enable a client device 130 to recognize a spoken query and thereafter instruct a downstream application to fulfil the query. Additionally or alternatively, the inputs 133 may include an image and the on-device ML model 135 may perform image classification or object recognition as an output 136. In other examples, the on-device ML model 135 includes a speech-to-speech model, a language model, a language translation model, a machine translation model, or other type of neural network model that is trained via ML to generate outputs 136 based on received inputs 133.

During training, the on-device ML engine 134 processes, using the on-device ML model 135, private data 139 stored in a datastore 140 (e.g., residing on the memory hardware 138) to generate one or more predicted private outputs 141. In some examples, the private data 139 and the public data 160 are derived from a common, similar, or same distribution of sources.

A gradient engine 142 generates one or more differentially private (DP) gradients 143 based on the predicted private output(s) 141. In some implementations, the gradient engine 142 generates the DP gradient(s) 143 based on comparing the predicted private output(s) 141 to private ground truth(s) 144 corresponding to the private data 139 using supervised learning techniques. In additional or alternative implementations, such as when the private ground truth(s) 144 corresponding to the private data 139 are unavailable, the gradient engine 142 generates the DP gradient(s) 143 using supervised and/or unsupervised learning techniques. The client device 130 transmits the DP gradient(s) 143 generated/output from the gradient engine 142 of the ML module 132 to the remote system 110 over the network(s) 170. In some examples, the client device 130 transmits the DP gradients 143 to the remote system 110 as they are generated by the gradient engine 142. Additionally or alternatively, the client device 130 may store the DP gradients 143 (e.g., on the memory hardware 138) and then retrieve and send the DP gradients 143 in batches to the remote system 110. Notably, the client device 130 may transmit the DP gradients 143 to the remote system 110 without transmitting any of the private data 139, the private ground truth(s) 144, the predicted private output(s) 141, and/or any other personally identifiable information. In various implementations, the client device 130 transmits the DP gradient(s) 143 to the remote system 110 in response to determining one or more conditions are satisfied. Example conditions include an indication that the client device 130 is charging, a state of charge of the client device 130 satisfying a threshold state of charge, a temperature of the client device 130 (based on one or more on-device temperature sensors) is less than a threshold temperature, an indication that the client device 130 is not being held by a user, temporal condition(s) associated with the client device(s) 130 (e.g., between a particular time period, every N hours, where N is a positive integer, and/or other temporal condition(s) associated with the client device(s) 130), and/or whether a threshold number of DP gradient(s) 143 have been generated by the client device 130.

In some examples, the gradient engine 142 determines the DP gradients 143 by determining a private loss function based on a predicted private output 141 and a corresponding private ground truth 144, derives a private gradient from the determined private loss function, and adds noise to the derived private gradient to generate a corresponding DP gradient 143. In some examples, the private loss function is convex and L-Lipschitz. Here, the effect of adding noise in any direction is inversely proportional to the curvature of the private loss function in that direction.

In additional or alternative implementations, the gradient engine 142 derives the DP gradients 143 from a private loss function used to train the on-device ML model 135, such that a DP gradient 143 represents a value of that private loss function (or a derivative thereof) obtained from comparison of the private ground truth(s) 144 to the predicted private output(s) 141 (e.g., using supervised learning techniques). For example, when the private ground truth(s) 144 and the predicted private output(s) 141 match, the gradient engine 142 can generate a zero DP gradient 143. Also, for example, when the private ground truth(s) 144 and the predicted private output(s) 141 do not match, the gradient engine 142 can generate a non-zero DP gradient 143 that is dependent on the extent of the mismatching. The gradient engine 142 can determine the extent of the mismatching based on an extent of mismatching between deterministic comparisons of the private ground truth(s) 144 and the predicted private output(s) 141. In additional or alternative implementations, the gradient engine 142 can derive the DP gradients 143 from a private loss function used to train the on-device ML model 135, such that the DP gradient 143 represents a value of that private loss function (or a derivative thereof) determined based on the predicted private output(s) 141 (e.g., using supervised or semi-supervised learning techniques).

As described in greater detail below, the private data 139 may include audio data generated by microphone(s) of the client device 130, textual segment( )provided as input by a user of the client device 130 and/or stored on the memory hardware 138, image data captured by an imaging device in communication with the client device 130, and/or any other data that is captured by, or generated locally at, the client device 130 and processed using the on-device ML model 135. In some implementations, the on-device ML model 135 processes the private data 139 to generate the DP gradient(s) 143 when the private data 139 is generated or provided to the client device 130 in a synchronous manner. In additional or alternative implementations, the private data 139 can be stored in the datastore 140 when the private data 139 is generated or provided to the client device 130, and the private data 139 can be subsequently utilized to generate the DP gradient(s) 143 in an asynchronous manner. In additional or alternative implementations, the on-device ML engine 134 processes the private data 139 to generate the predicted private output(s) 141, and the client device 130 stores or caches the predicted private output(s) 141 can be stored or cached at the client device 130 (optionally in association with the private data 139 associated with the predicted private output(s) 141) for subsequent utilization by the gradient engine 142 to generate the DP gradient(s) 143 in an asynchronous manner. The private data 139 (also referred to herein as on-device memory or on-device storage) can include any data generated or provided to the client device 130 including, but not limited to, audio data, image data, contact lists, electronic messages (e.g., text messages, emails, social media messages, etc.) sent by a user of the client device 130 or received by the user of the client device 130, and/or any other client data. Notably, the private data 139 corresponds to access-restricted data, or data that is not publicly available and/or available to the remote system 110.

The remote system 110 includes data processing hardware 112 and memory hardware 113 in communication with the data processing hardware 112. The memory hardware 113 stores instructions that, when executed by the data processing hardware 112, causes the data processing hardware 112 to perform one or more operations.

During training, a global ML engine 114 of the remote system 110 processes public data 160, using the global ML model 150, to generate predicted public output(s) 115. The public data 160 can be obtained from a datastore 121 (e.g., residing on the memory hardware 113) of public data 160. In some examples, the private data 139 and the public data 160 are derived from a common, similar, or same distribution of sources. The outputs 115 are referred to herein as predicted public outputs 115 to denote that they are generated based on the public data 160 not that they are necessarily publicly disclosed outside the remote system 110. However, the predicted public gradients 117 may be publicly exposed. The datastore 119 can include any data that is accessible by the remote system 110 including, but not limited to, public data repositories that include audio data, textual data, and/or image data, and private data repositories. Further, the datastore 119 can include data from different types of client devices 130 that have different device characteristics or components. For example, the database 119 can include audio data captured by near-field microphone(s) (e.g., similar to audio data captured by the client device 130) and audio data captured by far-field microphone(s) (e.g., audio data captured by other devices). As another example, the database 119 can include image data (or other vision data) captured by different vision components, such as RGB image data, RGB-D image data, CMYK image data, and/or other types of image data captured by various different vision components. Moreover, the remote system 110 can employ one or more techniques to the public data 160 to modify the public data 160. These techniques can include filtering audio data to add or remove noise when the public data 160 is audio data, blurring images when the public data 160 is image data, and/or other techniques to manipulate the public data 160. This allows the remote system 110 to better reflect client data generated by a plurality of different client devices 130 and/or satisfy a need for a particular type of data (e.g., induce false positives or false negatives as described herein, ensure sufficient diversity of audio data as described herein, etc.).

A gradient engine 116 generates one or more public gradients 117 based on the predicted public output(s) 115. The gradients 117 are referred to herein as public gradients 117 to denote that they are generated based on the public data 160 not that they are necessarily publicly disclosed outside the remote system 110. However, the public gradients 117 may be publicly exposed. In some implementations, the gradient engine 116 generates the public gradient(s) 117 based on comparing the predicted public output(s) 115 to public ground truth(s) 118 corresponding to the public data 160 using supervised learning techniques. In additional or alternative implementations, such as when the public ground truth(s) 118 corresponding to the public data 160 are unavailable, the gradient engine 116 can generate the public gradient(s) 117 using supervised and/or unsupervised learning techniques. The public gradient(s) 117 and along with DP gradient(s) 143 received from the client devices 130 can be stored in a gradients datastore 119 stored in a central repository on the remote system 110 (e.g., long-term memory and/or short-term memory, such as the memory hardware 113 or a buffer).

In some examples, the gradient engine 116 determines a public gradient 117 by determining a public loss function based on a public predicted output 115 and a corresponding public ground-truth 118, and deriving the public gradient from the determined public loss function. In some examples, the public loss function is strongly convex.

As noted above, the public and/or private gradients 117, 143 can be stored in the gradients datastore 119 (or other memory (e.g., a buffer)) as the gradients 117, 143 are generated and/or received. In some implementations, the gradients 117, 143 can be indexed by a type of gradient, from among a plurality of different types of gradients, that is determined based on the corresponding on-device ML model 135 that processed the private data 139 and/or the corresponding global ML model 150 that processed the public data 160. The plurality of disparate types of gradients can be defined with varying degrees of granularity. For example, the types of gradients can be particularly defined, for example, hotword gradients generated based on processing audio data using hotword model(s), ASR gradients generated based on processing audio data, VAD gradients generated based on processing audio data using VAD model(s), continued conversation gradients generated based on processing audio data using continued conversation model(s), voice identification gradients generated based on processing audio data using voice identification model(s), face identification gradients generated based on processing image data using face identification model(s), hotword free gradients generated based on processing image data using hotword free model(s), object detection gradients generated based on processing image data using object detection model(s), text-to-speech (TTS) gradients generated based on processing textual segments using TTS model(s), and/or any other gradients that may be generated based on processing data using any other ML model. Notably, a given one of the gradients 117, 143 can belong one to one of the multiple different types of gradients. As another example, the types of gradients can be more generally defined as, for example, audio-based gradients generated based on processing audio data using one or more audio-based models, image-based gradients generated based on processing image data using one or more image-based models, or text-based gradients generated based on processing textual segments using text-based models.

A training engine 200 can utilize the DP gradient(s) 143 and the public gradient(s) 117 to update one or more weights of the global ML model 150. In some implementations, the remote system 110 assigns the public gradients 117 and the DP gradients 143 to specific iterations of updating the global ML model 150 based on one or more criteria. The one or more criteria can include, for example, the types of gradients available to the training engine 200, a threshold quantity of gradients available to the training engine 200, a threshold duration of time of updating using the gradients, and/or other criteria. In particular, the training engine 200 can identify multiple sets or subsets of the DP gradients 143 and/or the public gradients 117 to use for training the global ML model 150. Further, the training engine 200 can update the global ML model 150 based on these sets or subsets of the gradients. In some further versions of those implementations, a quantity of gradients in a set of DP gradients 143 and in a set of public gradients 117 are the same or vary (e.g., proportional to one another and having either more DP gradients 143 or more public gradients 117). In other implementations, the remote system 110 utilizes the DP gradients 143 and the public gradients 117 to update the global ML model 150 in a first in, first out (FIFO) manner without assigning the gradients 117, 143 to specific iterations of updating the global ML model 150.

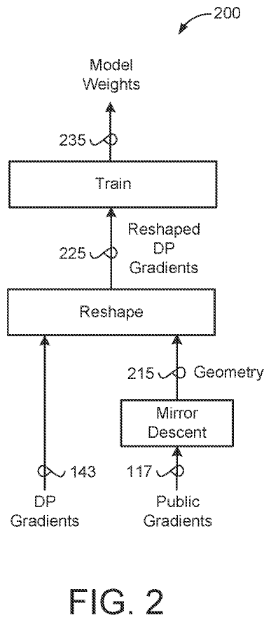

FIG. 2 is a schematic view of a training process 200 that leverages the public data 160 with private mirror descent to train the global ML model 150. The training process 200 applies mirror descent to the public gradients 117 to learn a geometry 215 of the public gradients 117. The training process 200 may apply mirror descent by using the public gradients 117 derived from a public loss function as a mirror map to learn the geometry 215 of the set of DP gradients.

The training process 200 reshapes the DP gradients 143 using the learned geometry 215 such that reshaped DP gradients 225 conform to the learned geometry 215. The training process 200 then trains the global ML model 150 by learning updated weights 235 for the global ML model 150. In some examples, the training process 200 updates the weights 235 using stochastic gradient descent.

The distribution engine 111 may transmit an updated global ML model 150 and/or weights thereof to the client device(s) 130. In some implementations, the distribution engine 111 transmits an updated global ML model 150 and/or weights thereof responsive to one or more conditions being satisfied for the client device(s) 130 and/or the remote system 110. Upon receiving the updated global ML model 150 and/or the weights thereof, the client device(s) 130 replace or update a corresponding on-device ML model 135 with the updated global ML model 150, or replace weights of the corresponding on-device ML model 135 with the weights of the updated global ML model 150. Further, a client device 130 may subsequently use the updated on-device ML model 135 and/or the weights thereof to make predictions based on further user input(s) 133 detected at the client device 130. The client device(s) 130 can continue generating further DP gradients 143 in the manner described herein and transmitting the further DP gradients 143 to the remote system 110. Further, the remote system 110 can continue generating further public gradients 117 in the manner described herein and updating the global MI, model 150 based on the further DP gradients 143 and/or the further public gradients 117.

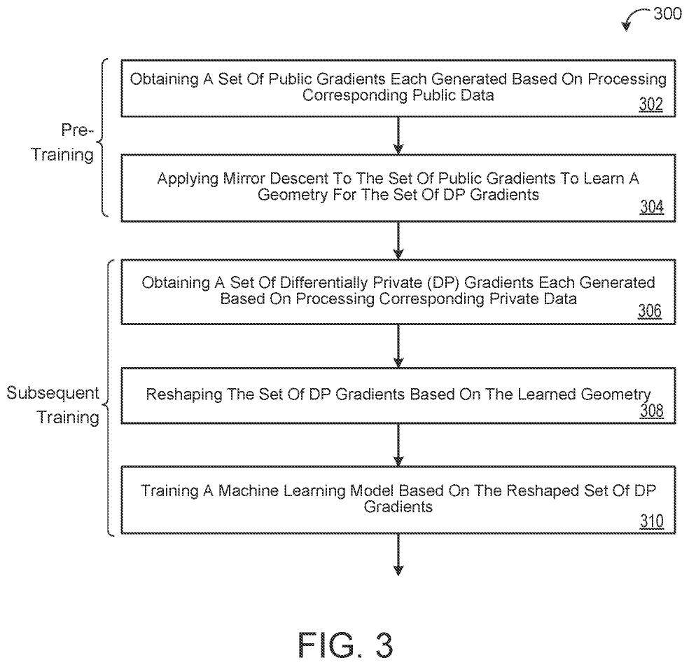

FIG. 3 is a flowchart of an exemplary arrangement of operations for a computer-implemented method 300 for leveraging public data 160 in training a neural network with private mirror descent. During an initial or pre-training of a machine learning model 150, the method performs operations 302 and 304. At operation 302, the method 300 includes obtaining a set of public gradients 117 each generated based on processing corresponding public data 160. At operation 304, the method 300 includes applying mirror descent to the set of public gradients 117 to learn a geometry 215 of the public gradients 117 that may be applied to or for a set of DP gradients 143. For example, by using the public gradients 117 derived as a mirror map to learn the geometry 215 for the set of DP gradients 143.

During subsequent training or updates of the machine learning model 150, the method performs operations 306, 308, and 310. At operation 306, the method 300 includes obtaining the set of differentially private (DP) gradients 143 each generated based on processing corresponding private data 139. At operation 308, the method includes reshaping the set of DP gradients 143 based on the learned geometry 215. At operation 310, the method 300 includes training or updating the machine learning model 150 based on the reshaped set of DP gradients.

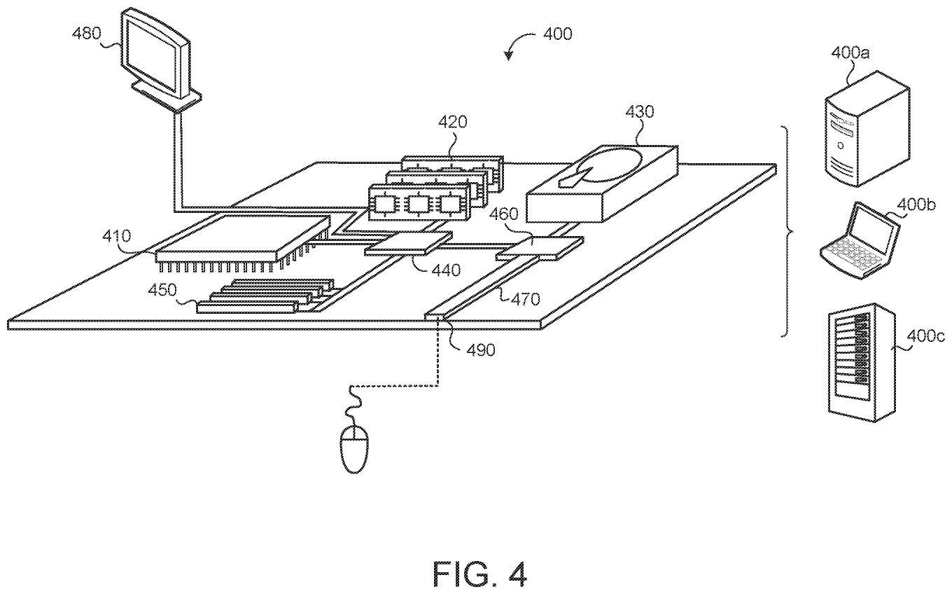

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 137 and/or 112, memory 420 (i.e., memory hardware) that can be used to implement the memory hardware 138 and/or 113, a storage device 430 (i.e., memory hardware) that can be used to implement the memory hardware 138 and/or 113, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, “or” refers to an inclusive or and not to an exclusive or. For example, “A, B, or C” refers to any combination or subset of A, B, C such as: (1) A alone; (2) B alone; (3) C alone; (4) A with B; (5) A with C; (6) B with C; and (7) A with B and with C. Similarly, the phrase “at least one of A or B” is intended to refer to any combination or subset of A and B such as: (1) at least one A; (2) at least one B; and (3) at least one A and at least one B. Moreover, the phrase “at least one of A and B” is intended to refer to any combination or subset of A and B such as: (1) at least one A; (2) at least one B; and (3) at least one A and at least one B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
obtaining a set of differentially private (DP) gradients each generated based on processing corresponding private data;
obtaining a set of public gradients each generated based on processing corresponding public data;
applying mirror descent to the set of public gradients to learn a geometry for the set of DP gradients;
reshaping the set of DP gradients based on the learned geometry; and
training a machine learning model based on the reshaped set of DP gradients.

2. The method of claim 1, wherein each DP gradient in the set of DP gradients is generated by:
processing, using a machine learning model, corresponding private data to generate a corresponding predicted private output;
determining a private loss function based on the corresponding predicted private output and a corresponding private ground truth; and
adding, to a private gradient derived from the private loss function, noise to generate the DP gradient.

3. The method of claim 2, wherein the private loss function is convex and L-Lipschitz.

4. The method of claim 1, wherein the private data and the public data are derived from a same distribution of sources.

5. The method of claim 1, wherein each public gradient in the set of public gradients is generated by:
processing, using a machine learning model, corresponding public data to generate a corresponding predicted public output;
determining a public loss function based on the corresponding predicted public output and a corresponding public ground truth; and
deriving the public gradient from the public loss function.

6. The method of claim 5, wherein applying mirror descent to the set of public gradients to learn the geometry for the set of DP gradients comprises applying mirror descent by using the public gradients derived from the public loss function as a mirror map to learn the geometry for the set of DP gradients.

7. The method of claim 5, wherein the public loss function is strongly convex.

8. The method of claim 1, wherein:
the data processing hardware resides on a central server; and
the set of DP gradients and the set of public gradients are stored in a central repository residing on the central server.

9. The method of claim 1, wherein:
the data processing hardware resides on a remote system;
obtaining the set of DP gradients comprises receiving the set of DP gradients from one or more client devices via federated learning without receiving any of the corresponding private data; and
each DP gradient in the set of DP gradients is generated locally at a respective one of the one or more client devices.

10. The method of claim 1, wherein the machine learning model comprises an image classification model.

11. The method of claim 1, wherein the machine learning model comprises a language model.

12. The method of claim 1, wherein the machine learning model comprises a speech recognition model.

13. A system comprising:
data processing hardware; and
memory hardware in communication with the data processing hardware, the memory hardware storing instructions that when executed on the data processing hardware cause the data processing hardware to perform operations comprising:
obtaining a set of differentially private (DP) gradients each generated based on processing corresponding private data;
obtaining a set of public gradients each generated based on processing corresponding public data;
applying mirror descent to the set of public gradients to learn a geometry for the set of DP gradients;
reshaping the set of DP gradients based on the learned geometry; and
training a machine learning model based on the reshaped set of DP gradients.

14. The system of claim 13, wherein each DP gradient in the set of DP gradients is generated by:
processing, using a machine learning model, corresponding private data to generate a corresponding predicted private output;
determining a private loss function based on the corresponding predicted private output and a corresponding private ground truth; and
adding, to a private gradient derived from the private loss function, noise to generate the DP gradient.

15. The system of claim 14, wherein the private loss function is convex and L-Lipschitz.

16. The system of claim 13, wherein the private data and the public data are derived from a same distribution of sources.

17. The system of claim 13, wherein each public gradient in the set of public gradients is generated by:
processing, using a machine learning model, corresponding public data to generate a corresponding predicted public output;
determining a public loss function based on the corresponding predicted public output and a corresponding public ground truth; and
deriving the public gradient from the public loss function.

18. The system of claim 17, wherein applying mirror descent to the set of public gradients to learn the geometry for the set of DP gradients comprises applying mirror descent by using the public gradients derived from the public loss function as a mirror map to learn the geometry for the set of DP gradients.

19. The system of claim 17, wherein the public loss function is strongly convex.

20. The system of claim 13, wherein:
the data processing hardware resides on a central server; and
the set of DP gradients and the set of public gradients are stored in a central repository residing on the central server.

21. The system of claim 13, wherein:
the data processing hardware resides on a remote system;
obtaining the set of DP gradients comprises receiving the set of DP gradients from one or more client devices via federated learning without receiving any of the corresponding private data; and
each DP gradient in the set of DP gradients is generated locally at a respective one of the one or more client devices.

22. The system of claim 13, wherein the machine learning model comprises an image classification model.

23. The system of claim 13, wherein the machine learning model comprises a language model.

24. The system of claim 13, wherein the machine learning model comprises a speech recognition model.
